(19) United States
(12) Patent Application Publication
(10) Pub. No.: US 2024/0059446 A1
(43) Pub. Date: Feb. 22, 2024

(54) SYSTEM AND METHOD TO AUTOMATE FOLDING AND PACKAGING AN ITEM FOR SHIPPING

(71) Applicant: Kornit Digital Ltd., Rosh HaAyin (IL)

(72) Inventors: Guy AVIDAN, Zichron Yaakov (IL); Jacob MANN, Zoran (IL); Omer KULKA, Tel Aviv (IL); Allon SHIMONI, Modiin-Maccabim-Reut (IL)

(73) Assignee: Kornit Digital Ltd., Rosh HaAyin (IL)

(21) Appl. No.: 18/038,043

(22) PCT Filed: Dec. 9, 2021
(86) PCT No.: PCT/IL2021/051468

§ 371 Date: May 22, 2023

Related U.S. Application Data
(60) Provisional application No. 63/122,977, filed on Dec. 9, 2020.

(51) Int. Cl. B65B 57/12; B65B 11/56; B65B 25/20; B65B 59/00; B65B 61/02; B65B 61/26

(52) U.S. Cl. CPC B65B 57/12; B65B 11/56; B65B 25/20; B65B 59/003; B65B 61/025; B65B 61/26; B65D 75/14

(57) ABSTRACT

An automated system for packaging an item includes a pallet, a packaging station and a controller. The pallet supports both the item and a packaging layer. The package is formed with the packaging layer. The packaging station folds the item and the packaging layer such that the item is enclosed within the packaging layer. The controller controls operation of the system. The item may be for example a textile, a digitally printed textile and/or a garment.

### RELATED APPLICATION

This application claims the benefit of priority of U.S. Provisional Patent Application No. 63/122,977 filed on Dec. 9, 2020, the contents of which are incorporated herein by reference in their entirety.

### FIELD AND BACKGROUND OF THE INVENTION

The present invention, in some embodiments thereof, relates to automated folding and packaging of items and, more particularly, but not exclusively, to automated packaging of an individual garment for shipping to an end consumer.

Online shopping has altered the process for distributing garments to an end customer. Traditionally, garments were packaged in bulk quantities and distributed to a retail site. The garments were typically individually wrapped, e.g. with a plastic wrapping, however a more robust packing box was only required for packaging the bulk quantity. The end customer would arrive at the retail site and purchase a selected garment.

Distribution with online shopping, requires individually packaging a selected garment so that it can be shipped to the end customer. Typically, the garment is individually wrapped, inserted in a pre-formed package suitable for shipping and labeled with a shipping label. Often, the pre-formed packages are significantly larger than required for the garment. The need to package individual products for shipping is costly and environmentally wasteful. Packaging and shipping costs often makeup a significant portion of the total cost of design to delivery garments. Furthermore, due to the low volume high mix, mismatches are prone to occur between the product packaged and the shipping label printed so that the garment does not reach its proper destination.

Textile printing is widely practiced, and applied to everything from rolls of fabric to already made garments. Based on the online shopping model, an end customer may customize and/or select a desired ornament to be printed on a garment and receive the garment directly from a manufacturing site, e.g. a printing site.

### SUMMARY OF THE INVENTION

According to an aspect of some embodiments of the present invention there is provided a system and method for packaging individual orders of an item, e.g. a textile or a garment. Optionally and preferably, the system and method also provides for printing an ornament, e.g. a customized or selected design on the item. According to some example embodiments, the system and method provide for compactly packaging the item with a package that is sized according to the item being packaged. Since textiles and/or garments are characterized as high volume versus weight, reducing volume of the package may significantly reduce shipping costs as well as carbon footprint. In some example embodiments, the system and method further provides for eliminating the time, expense and wastefulness of first wrapping the item and then inserting the wrapped item in a preformed package. Instead, the item may be folded together with a packaging layer that forms the package with the item inside in an integrated fold and pack process.

According to some example embodiments, when printing capability is available, shipping data or order data is printed directly on the item and the packaging is configured to visually expose the data printed on the item. The present inventors have found that based on integrating the printing and labeling process, time, labor and material may be conserved and mismatches may be significantly reduced. According to some example embodiments, the printing packaging and labeling is performed in an automated process without human intervention.

According to an aspect of some example embodiments, there is provided an automated system for packaging an item, the system comprising: a pallet configured for supporting both the item and a packaging layer during an automated packaging process, wherein the packaging layer is configured for forming a package for the item; a packaging station configured for folding the item and the packaging layer, wherein the folding forms the package with the item enclosed therein; and controller configured for controlling operation of the system.

Optionally, the packaging station is configured for folding the item concurrently with forming the package in which the item is enclosed.

Optionally, the folding the item and the packaging layer includes rolling the item and the packaging layer to form the package.

Optionally, the item is configured to be overlaid on the packaging layer in an unfolded stated.

Optionally, the system further includes a printing station, wherein the printing station is configured for printing content on the item and/or the packaging layer.

Optionally, the controller is configured to receive content related to a purchase order of the item and provide the content to the printing station.

Optionally, the content includes shipping data for shipping the item to an end customer and/or a shipping label.

Optionally, the printing station is configured for printing scented material on the item and/or on the packaging layer.

Optionally, the system further includes a creasing device configured for forming fold lines, micro-cuts and/or holes on the packaging layer.

Optionally, the controller is configured to define the fold lines based on a parameter of the item and/or a detail related to a purchase order of the item and to dynamically adjust the fold lines during operation of the system.

Optionally, the packaging layer is pre-formed with a window covered with a transparent film.

Optionally, the system further includes a cutting device configured to cut a window in the packaging layer, wherein the controller is configured to define a size, shape and/or location for a window through which a portion of the item is to be exposed and wherein the cutting device is configured to cut out the window as defined by the controller.

Optionally, the controller is configured to align the window with a shipping label printed on the item.

Optionally, the system further includes a positioning station configured for mounting the item over the packaging layer.

According to an aspect of some example embodiments, there is provided an automated system for packaging an item, the system comprising: a pallet configured for supporting the item; a controller configured for receiving content to be printed on the item; a printing station configured for printing the content on the item; and a packaging station configured for packaging the item in a package including a window configured for exposing at least a portion of the content.

Optionally, the content includes order data related a purchase order of the item.

Optionally, the order data includes shipping data and/or a shipping label including postage for shipping the item and wherein the window is configured for exposing the shipping data and/or the shipping label.

Optionally, the printing station is configured for printing scented material on the item and/or on the package.

Optionally, the packaging station is configured for folding the item together with a packaging layer on which the item is overlaid, wherein the folding forms the package from the packaging layer with the item enclosed therein.

Optionally, the packaging station further comprises a cutting device configured to cut out the window on the package in alignment with the at least a portion of the content.

Optionally, the system further includes a positioning station configured for mounting the item on the pallet.

Optionally, the system further includes a sealing device configured to seal the package with tape glue and/or a film that is at least partially transparent.

Optionally, the packaging station further comprises a suction device configured to suction air out of the package.

Optionally, the system further includes a scale configured for weighing the package.

Optionally, the package is formed from corrugated sheet or cardboard.

Optionally, the system is configured to be operated in an automated process without human intervention.

According to an aspect of some example embodiments, there is provided a method for packaging an item in an automated process, the method comprising: receiving the item and a packaging layer on a pallet of an automated packaging system for packaging an item in a package configured for shipping; and folding the item and the packaging layer, wherein the folding forms the package with a window through which a selected portion of the item is visible therethrough, wherein the folding is performed by the automated packaging system in an automated process.

Optionally, folding the item is performed concurrently with forming the package in which the item is enclosed.

Optionally, the folding includes rolling the item and the packaging layer to form the package.

Optionally, the method further includes printing content on the item and/or the packaging layer, wherein the content is related to a purchase order of the item.

Optionally, the method further includes forming fold lines, micro-cuts and/or holes on the packaging layer.

Optionally, the method further includes cutting out a window in the packaging layer, wherein the window is configured to expose a portion of the item.

Optionally, the method further includes printing shipping data on the item; and aligning a window formed on the package to expose the shipping data through the window.

Optionally, the item is a textile item.

Optionally, the textile item is a digitally printed textile item.

Optionally, the textile item is a garment.

According to an aspect of some example embodiments, there is provided a method for packaging an item, the method comprising: receiving the item on a pallet of an automated packaging system; printing content on the item; packaging the item in a package formed with a window; and aligning the window with the content to expose at least a portion of the content.

Optionally, the content is related to a purchase order of the item.

Optionally, the content includes shipping data for shipping the item to an end customer.

Optionally, the method further includes folding the item together with a packaging layer to form the package.

Optionally, the content includes shipping data for shipping the item.

Optionally, the shipping data is a shipping label including postage.

Optionally, the method further includes sealing the package with tape glue and/or an additional layer that is at least partially transparent.

Optionally, the method further includes suctioning air out of the package.

Optionally, the method further includes selecting a scent based on at least one detail related to the item and/or to an end customer ordering the item; and dispensing the scent on the item and/or the packaging.

Optionally, the item is a textile item.

Optionally, the textile item is a digitally printed textile item.

Optionally, the textile item is a garment.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWING(S)

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a simplified block diagram of an example automated folding and packaging system for preparing a garment for shipping in accordance with some example embodiments;

FIG. 2 is a simplified flow chart of an example method for folding and packaging a garment for shipping in an automated process in accordance with some example embodiments;

FIG. 3 is a simplified flow chart of an example method for folding a garment with a packaging layer in an automated process to prepare a package formed with the packaging layer for shipping in accordance with some example embodiments;

FIG. 4 is a simplified flow chart of an example method to print purchase related data on a garment and to package the garment with the purchase related data visible through the package, in accordance with some example embodiments;

FIGS. 5A, 5B and 5C are simplified schematic drawings of example packages including a window for visually exposing a portion of a garment, the packages constructed in an automated process in accordance with some example embodiments; and

FIGS. 6A, 6B and 6C are simplified schematic drawings of example packages constructed in an automated process with shipping labels in accordance with some example embodiments.

### DESCRIPTION OF SPECIFIC EMBODIMENTS OF THE INVENTION

The present invention, in some embodiments thereof, relates to automated folding and packaging of items and, more particularly, but not exclusively, to automated packaging of an individual garment for shipping to an end consumer.

According to an aspect of some example embodiments, an automated system for packaging an item, e.g. textile or garment includes a packaging station configured for folding the item with a packaging layer and a controller configured for controlling operation of the system in an automated process without human intervention. According to some example embodiments, the packaging layer includes or is formed with a window through which a selected portion of the item is visible. In some example embodiments, the system includes a printer for printing content on the item and/or on the packaging layer. In some example embodiments, the printer is configured for printing an ornament as well as shipping data on the item. Optionally, the printer is a digital printer. Optionally, the shipping data is a shipping label or part of a shipping label. In some example embodiments, the printer or other device may print or dispense a scent on the item and/or the packaging layer. Optionally, the item is dried or cured after printing and before packaging.

According to some example embodiments, the package is folded around the item to form a compact package and to properly align the window with a selected portion of the item, e.g. the portion including the shipping data. Optionally, the folding is dynamically adjusted on-the-fly to properly align the window with the item and/or to adjust a size of the package to a size of the item. In some example embodiments, the system includes a creasing device configured for forming fold lines, micro-cuts or holes on the packaging layer, e.g. when the packaging layer is formed from a rigid or stiff material. One or more holes may be introduced to allow extracting air, e.g. passively or by pressing to reduce volume. The window may be pre-formed on the packaging layer or may be formed during the automated process with a cutting device. Optionally, location and size of the window is dynamically adjusted, e.g. adjusted on-the-fly. According to some example embodiments, the window is covered with a transparent film. Optionally, the transparent film is configured to adhere to the garment so that the relative positioning between the garment and the window may be maintained.

In some example embodiments, the system additionally includes a suctioning device configured to reduce volume of the package, e.g. vacuum pack the package. Optionally, the system additionally includes a scale configured for monitoring a weight of the package. In some example embodiments, the system additionally includes a mounting device configured for position the garment and optionally the packaging layer on a pallet of the system. According to some example embodiments, the packaging layer is cardboard or coagulated material. Optionally, the garment is a t-shirt.

According to an aspect of some example embodiments, there is provided a method for packaging an item in an automated process that includes receiving purchase order data for the item, receiving the item with a packaging layer positioned under the item, and folding the item with the packaging layer. According to some example embodiments, the folding process forms a package with a window through which a selected portion of the item is visible. According to some example embodiments, the method further includes printing content on the item prior to folding. Optionally, the content includes purchase order data, e.g. shipping data or a shipping label. According to some example embodiments, the purchase order information printed on the item is aligned with the window during the folding process. Optionally, purchase order data may be printed on the package itself. Optionally, the item and/or the packaging layer may be scented with a selected scent. Optionally, the package may be vacuum packed to reduce volume.

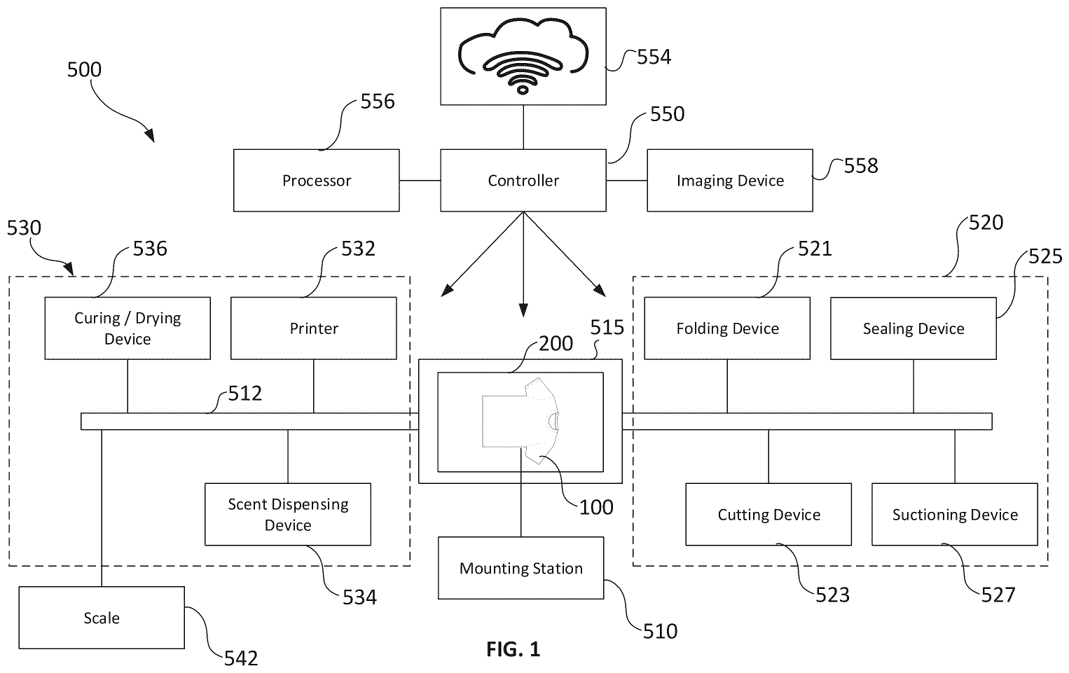

Reference is now made to FIG. 1 showing a simplified block diagram of an example automated folding and packaging system for preparing a garment for shipping in accordance with some example embodiments. A system 500 includes a pallet 515 on which a garment 100 (or other item) and a packaging layer is supported during an automated folding and packaging process and a packaging station 520 for packaging the garment for shipping, e.g. mailing to an end customer with the packaging layer 200. Optionally and preferably, system 500 additionally includes a printing station 530 for printing on garment 100 and/or on packaging layer 200. Each of packaging station 520 and printing station 530 may include a plurality of devices. The devices in each station may be physically clustered for example as shown in FIG. 1 or may be arranged in a different manner. Optionally, one or more of the devices associated with printing station 530 may be positioned near one or more devices associated with packaging station 520.

In some example embodiments, system 500 additionally includes a mounting device 510 for mounting garment 100 and/or packaging layer 200 on pallet 515 in an automated process e.g., without human intervention. Mounting device 510 may for example include robotic grippers for pulling garment 100 and/or packaging layer 200 from a storage area and positioning garment 100 and/or packaging layer 200 on pallet 515. Optionally, garment 100 and/or packaging layer 200 may be manually positioned on pallet 515 and the mounting precedes the automated folding and packaging process. Optionally and preferably, each of packaging layer 200 and/or garment 100 are mounted on pallet 515 in a flat unfold state. Optionally and preferably, garment 100 is mounted on packaging layer 200. In some example embodiments, pallet 515 is mounted on a rail 512 and pallet 515 advances to one or more devices of system 500 over the automated folding and packaging process. Alternatively or additionally, one or more of devices in system 500 may advance in turn toward pallet 515.

In some example embodiments, packaging layer 200 is pre-cut or pre-formed shape that may include fold line indentations and/or a window through which a portion of garment 100 is visible after packaging. Optionally packaging layer 200 has a footprint larger than a foot print of garment 100 so that folding packaging layer 200 with garment 100 provides enclosing garment 100 within packaging layer 200. Packaging layer 200 may be for example cardboard, corrugated material, poly-coated paper and/or plastic. Packaging layer 200 may be formed from flexible or stiff (rigid) material. Optionally, more than one type of material for packaging layer 200 may be used with system 500. In some example embodiments, packaging layer 200 is a rectangular layer and is configured to be cut and folded during the automated folding and packaging process provided by system 500.

In some example embodiments, garment 100 is a t-shirt or sweatshirt. Other types of garments are contemplated including for example a button down shirt, a sweater, pants, a dress, undergarment, and/or a belt.

A controller 550 may control operation of system 500. Controller 550 may represent a single controller or a plurality of controllers that communicate via tethered and/or wireless channels. According to some example embodiments, controller 550 receives data related to a purchase order from an online order via internet 554 and prepares garment 100 for shipping to an end customer based on the data received. Data related to the purchase order may include for example size of garment 100, color of garment 100, and/or content to be printed on garment 100. According to some example embodiments, data related to the purchase order additionally includes shipping information for shipping garment 100 to the end customer. Optionally and preferably, data related to the purchase order provides information for printing a shipping label on packaging layer 200 and/or on garment 100 over the automated folding and packaging process performed by system 500.

According to some example embodiments, prior to folding and packaging garment 100, printer 532 prints content on garment 100. The content may be an ornamental design and/or content related to the purchase order of the garment. In some example embodiments, the content related to the purchase order of garment 100 is shipping data for shipping garment 100 to the end customer. Optionally, the shipping data is a shipping label with postage. Optionally, the shipping data printed on garment 100 is encoded in a manner that can be read (by scanning) in a mail distribution center for delivering the package to the end customer. Optionally, the shipping data is integrated into an ornamental design. In some example embodiments, processor 556 is configured to encode the shipping data and to provide the encoded shipping data to controller 550. The ornamental design, when it is included in the content may be selected or defined in the purchase order. According to some example embodiments, the content and location for printing the content is provided by controller 550. Printer 532 may be specifically configured for printing on fabric, e.g. garment 100 or may be configured for printing both on fabric and other material, e.g. on packaging layer 200.

In some example embodiments, printing station 530 includes a scent dispenser 534 configured to dispense a scent on garment 100 and/or packaging layer 200. Optionally, scent dispenser 534 is integral with printer 532, e.g. printer 532 dispenses the scent. The scent dispensed may be for example a generic scent or may be selected based on the data related to the purchase order. A curing and/or drying device 536 may be operated to cure and/or dry the garment 100 and/or the packaging layer 200 after printing, e.g. to cure or dry the printed material. In some example embodiments, system 500 includes a scaled for weighing garment 100 with packaging layer 200. Optionally, output from scale 542 is used to define the shipping label printed on garment 100 and/or packaging layer 200 when the shipping label includes postage.

According to some example embodiments, folding station 520 includes a folding device 521 that is configured to fold garment 100 and packaging layer 200. In some example embodiments, folding device 521 folds and/or rolls garment 100 with packaging layer 200, e.g. concurrently. In some example embodiments, folding device is configured to first fold garment 100 and subsequently fold packaging layer around garment 100. In some example embodiments, folding device 521 forms indentations and/or micro-cuts in packaging layer 200 that define fold lines. Optionally, the indentations and/or micro-cuts are dynamically positioned based on size and shape of garment 100 to provide a compact package that fits the size of the garment as folded. In some example embodiments, image data from an imaging device 558 provides input for dynamically positioning the fold lines. Optionally, the dynamic position is based on stored information related to size and shape of garment 100 and/or based on a defined shipping method.

In some example embodiments, a cutting device 523 cuts a window in packaging layer 200 for visually exposing a selected portion of garment 100. Optionally, the window is dynamically positioned based on size and shape of garment 100 to provide aligning the window with a desired portion of garment 100, e.g. a portion of garment 100 including shipping data. In some example embodiments, image data from an imaging device 558 provides input for dynamically adjusting, e.g. adjusting on-the-fly, the size and location of the window.

In some example embodiments, system 500 incudes a sealing device 525 configured for sealing the package formed based on folding packaging layer 200. In some example embodiments, sealing device 525 is configured for sealing a window formed with cutting device 523 with a transparent film, e.g. polystyrene. In some example embodiments, the transparent film is configured to seal the package and also adhere to a selected portion of the garment including printed content.

In some example embodiments, sealing device 525 is configured to apply glue and/or tape for sealing the package formed by folding packing layer 200. Optionally, system 500 additionally includes a suctioning device 527 configured to suction air out of the package formed. Optionally, the suctioning is configured for reducing a volume of the package. Since, garments are typically flexible and compressible, suctioning may significantly reduce volume of the package for shipping.

In some example embodiments, system 500 is configured to print content on the package formed, e.g. after the package is sealed. Optionally, printer 532 is configured to print shipping data, e.g. a shipping label on the package. In some example embodiments, printer 532 may print other content on the package, e.g. an ornament. Optionally, curing and/or drying device 536 may cure and/or dry the content printed on the package.

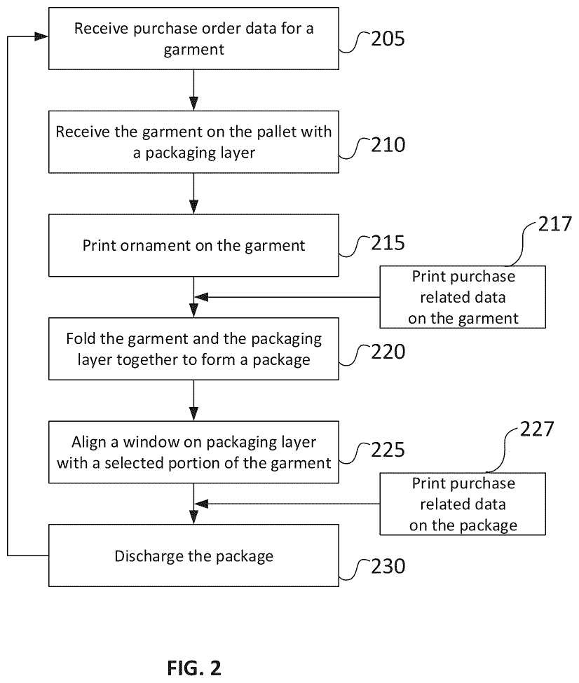

Reference is now made to FIG. 2 is a simplified flow chart of an example method for folding and packaging a garment for shipping in an automated process in accordance with some example embodiments. According to some example embodiments, system 500 receives purchase order data for a garment (block 205). The purchase order data may be received online via an internet connection. The garment may be received on a pallet of system 500 manually or in an automated manner with a robotic gripper that is optionally included in system 500 (block 210). Optionally, pallet may be pre-loaded with a packaging layer positioned under the garment. Optionally, both the packaging layer and the garment is received on the pallet manually or with the robotic gripper. In some example embodiments, an ornament is printed on the garment (block 215). Optionally, the ornament is selected and/or defined by an end customer providing the purchase order.

Optionally, purchase related data may include shipping data (block 217). Optionally, the purchase related data printed on the garment is encoded, e.g. in a linear or two dimensional barcode. Optionally, the printed code is or includes a virtual stamp, e.g. Intelligent Mail Barcode of the USPS, a 65-bar U.S. Postal Service barcode designed for bulk mailers to track and sort mail pieces such as flats and letters. Optionally, the encoded data may include a manufacturer code that provides connecting to various shippers and optimizing shipping scheme for customers.

In some example embodiments, the printing includes drying and/or curing the ink dispensed by printer. Optionally, the printing includes, is accompanied, or is followed by dispensing a selected scent on the garment and/or on the packaging layer.

According to some example embodiments, the garment is folded together with the packaging layer to form a package with a folded garment enclosed therein (block 220). Folding may optionally and/or additionally include rolling the garment and/or the packaging layer. Optionally, one or more folding steps of the automated folding process may be performed only on the garment and/or only on the packaging layer. Optionally, the folding process may include forming indentations and/or micro-cuts on the packaging layer to define fold lines for folding. Optionally, the folding is dynamically controlled with an imaging device to adjust the folding to dimensions of the garment. Optionally, the folding process additionally includes sealing, e.g. applying glue, tape, or a film on or around the package. Optionally, the folding process additionally includes suctioning air out of the package, e.g. vacuum packing the package.

The packaging layer may be formed with a window prior to being placed on the pallet or a window may be formed on the packaging layer during the automated process, e.g. during the folding process. Optionally and preferably, the window is covered with a transparent film. According to some example embodiments, the window (pre-formed or formed during the folding process) is aligned with a selected portion of the garment, e.g. to visually exposing a selected portion through the package (block 225). Optionally, the selected portion is a portion of the garment including content printed on the garment, e.g. an ornamental design and/or shipping data.

According to some example embodiments, after packaging, system 500 also prints content on the package (block 227). Optionally, purchase related data, e.g., a shipping data or a shipping label is printed on the package. Optionally, an ornamental design or message is printed on the package. According to some example embodiments, after the packaging and optionally the printing on the package, the package is discharged from the system and ready to be shipped to the end customer (block 230). Optionally, postage may be added to the package after discharging. Optionally, additional shipping data may be added to the package after discharging.

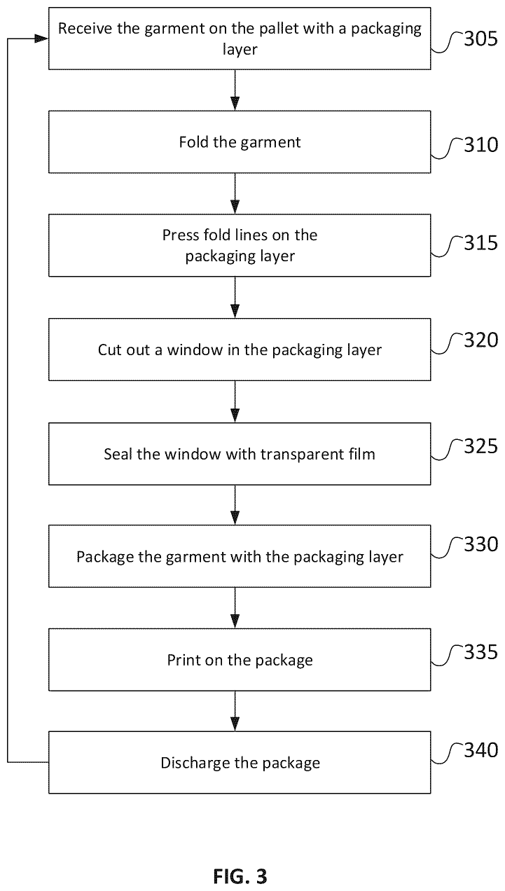

Reference is now made to FIG. 3 showing a simplified flow chart of an example method for folding a garment with a packaging layer in an automated process to prepare a package formed with the packaging layer for shipping in accordance with some example embodiments. According to some example embodiments, a garment is received on a pallet with a packaging layer (block 305). The garment and/or the packaging layer may be manually received and/or received as part of the automated process as described for example in reference to FIG. 2. In some example embodiments, the garment may be folded, e.g. fully or partially folded on the packaging layer (block 310). Optionally, fold lines are pressed (or micro-cuts are cut) on the packaging layer. Formation of the fold lines may be dynamically controlled by the automated system to match the dimensions of the garment as folded. Optionally, one or more windows at a selected location is cut out from the packaging layer (block 325). Size and position of the window may be dynamically controlled to adjust the window size and place to the portion of the garment that is configured to be visible through the window. Optionally and preferably, the window is sealed with a transparent film (block 330). Optionally, the film is configured to adhere to the portion of the garment that is configured to be visible through the window.

According to some example embodiments, the packaging layer is wrapped around the garment to package the garment therein (block 335). Wrapping around the garment may optionally and/or additionally include rolling the packaging layer. Optionally, the folding process additionally includes sealing, e.g. applying glue, tape, or a film on or around the package. Optionally, the folding process additionally includes suctioning air out of the package, e.g. vacuum packing the package. Optionally, one or more folding steps of the automated folding process may be performed only on the garment and/or only on the packaging layer. Optionally, the folding is dynamically controlled with an imaging device to adjust the folding to dimensions of the garment.

In some example embodiments, content is printed on the package (block 340). Optionally and preferably, the content is configured to identify the garment enclosed therein and or information regarding the end customer, e.g. shipping data and/or purchase order number. Optionally, a shipping label including postage is printed on the package. According to some example embodiments, the package is discharged from the system (block 345). Optionally, the package is ready for shipping to an end customer. Optionally, postage and/or shipping data is added to the package prior to shipping.

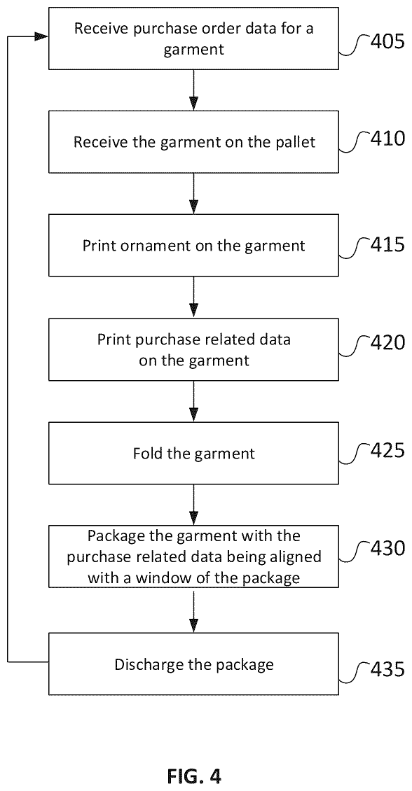

Reference is now made to FIG. 4 showing a simplified flow chart of an example method to print purchase related data on a garment and to package the garment with the purchase related data visible through the package, in accordance with some example embodiments. According to some example embodiments, system 500 receives purchase order data for a garment (block 405). The purchase order data may be received online via an internet connection. The garment may be received on a pallet of system 500 manually or in an automated manner with a robotic gripper that is optionally included in system 500 (block 410).

In some example embodiments, an ornament is printed on the garment (block 415). The ornament may be selected and/or defined by an end customer providing the purchase order. In some example embodiments, in addition to the ornament, purchase related data is also printed on a selected portion of the garment (block 420). Optionally, the purchase related data may be integrated into the ornament printed or an additional ornament. Optionally, purchase related data may include shipping data. Optionally, the purchase related data printed on the garment is encoded, e.g. in a linear or two dimensional barcode. In some example embodiments, the printing includes drying and/or curing the ink dispensed by printer. Optionally, the printing includes, is accompanied, or is followed by dispensing a selected scent on the garment and/or on the packaging layer.

According to some example embodiments, the garment is folded (block 425) and packaged in package that includes a window configured to visually expose the purchase related data (block 430). According to some example embodiments, the packaging includes aligning the purchase related data with the window, e.g. dynamically adjusting (adjusted on-the-fly) the packaging and/or the garment. Optionally, the packaging additionally includes sealing, e.g. applying glue, tape, or a film on or around the package. Optionally, the packaging additionally includes suctioning air out of the package, e.g. vacuum packing the package. According to some example embodiments, after packaging the package is discharged and ready for shipping to an end customer (block 435). Optionally, postage and/or additional shipping data is added to the package prior to shipping.

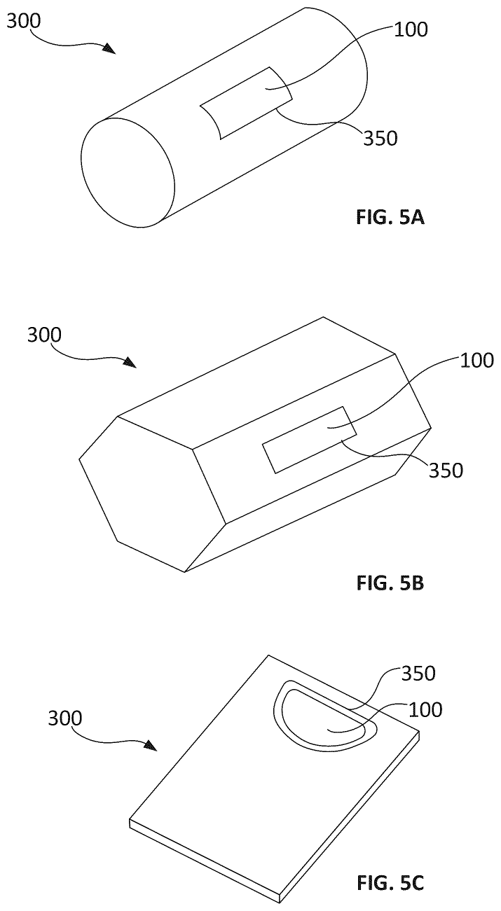

Reference is now made to FIGS. 5A, 5B and 5C showing simplified schematic drawings of example packages including a window for visually exposing a portion of a garment, the packages constructed in an automated process in accordance with some example embodiments. According to some example embodiments, a package 300 has a selected, e.g. customized size and shape suitable for a garment included therein and includes a window 350 configured to visually expose a selected portion of the garment. Package 300 may be formed with a packaging layer, e.g. sheet that is optionally folded into a package concurrently with the garment. The packaging layer used to form package 300 may be packaging layer 200 described herein. Window 350 may be covered with a transparent film welded or glued over an external and/or an internal surface of package 300. Optionally, package 300 includes a seam that is glued or taped. Optionally, package 300 is sealed with a transparent film. Optionally, package 300 is vacuumed packed.

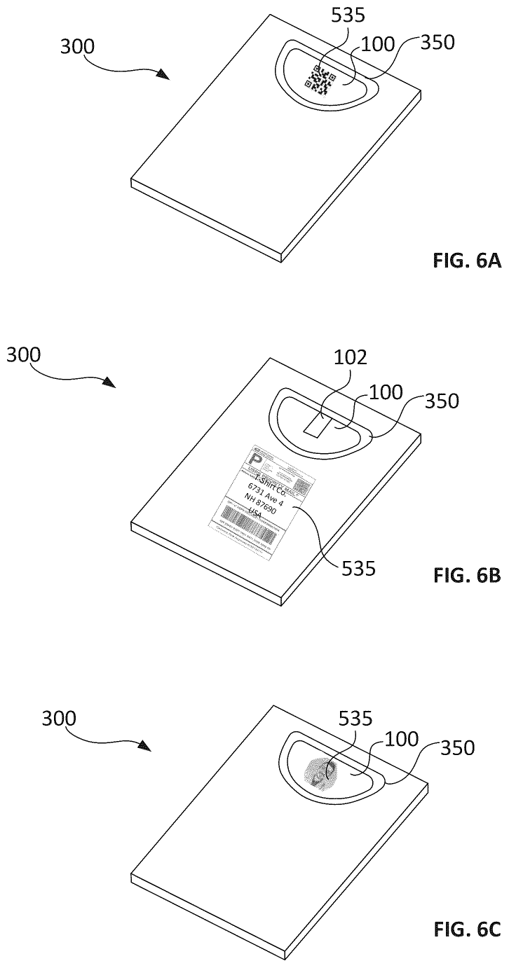

Reference is now made to FIGS. 6A, 6B and 6C showing simplified schematic drawings of example packages constructed in an automated process with shipping data in accordance with some example embodiments. According to some example embodiments, content 535 is printed on the garment 100 enclosed in package 300 and/or on package 300. In some example embodiments, the content is encoded data that may optionally be read by a scanner in a mail distribution center. Optionally, the encoded data includes a shipping address. Optionally, the encoded data is a shipping label including postage. Optionally, the encoded data includes a manufacture code. In some example embodiments, the encoded data may be printed on an inner neck tag 102 of garment 100. In some example embodiments, content 535 is encoded in an ornamental design (FIG. 6C). Optionally, the ornamental design includes an order number encoded therein and the order data may be used to prepare a shipping label to package 300.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

1. An automated system for packaging an item, the system comprising:
a pallet configured for supporting both the item and a packaging layer during an automated packaging process, wherein said packaging layer is configured for forming a package for said item;
a packaging station configured for folding the item and said packaging layer, wherein said folding forms said package with the item enclosed therein; and
controller configured for controlling operation of the system.

2. The system of claim 1, wherein said packaging station is configured for folding the item concurrently with forming said package in which the item is enclosed.

3. The system of claim 1 wherein said folding the item and said packaging layer includes rolling the item and said packaging layer to form said package.

4. The system according to claim 1, wherein the item is configured to be overlaid on said packaging layer in an unfolded stated.

5. The system according to claim 1, further comprising a printing station, wherein said printing station is configured for printing content on the item and/or said packaging layer.

6. The system according to claim 5, wherein said controller is configured to receive content related to a purchase order of the item and provide said content to said printing station.

7. The system according to claim 6, wherein said content includes shipping data for shipping the item to an end customer and/or a shipping label.

8. The system according to claim 5, wherein said printing station is configured for printing scented material on the item and/or on said packaging layer.

9. The system according to claim 1, further comprising a creasing device configured for forming fold lines, micro-cuts and/or holes on said packaging layer.

10. The system according to claim 9, wherein said controller is configured to define said fold lines based on a parameter of the item and/or a detail related to a purchase order of the item and to dynamically adjust said fold lines during operation of the system.

11. The system according to claim 1, wherein the packaging layer is pre-formed with a window covered with a transparent film.

12. The system according to claim 1, further comprising a cutting device configured to cut a window in said packaging layer, wherein said controller is configured to define a size, shape and/or location for a window through which a portion of the item is to be exposed and wherein said cutting device is configured to cut out said window as defined by said controller.

13. The system of claim 12, wherein said controller is configured to align said window with a shipping label printed on the item.

14. The system according to claim 1, further comprising a positioning station configured for mounting the item over the packaging layer.

15. An automated system for packaging an item, the system comprising:
a pallet configured for supporting the item;
a controller configured for receiving content to be printed on the item;
a printing station configured for printing said content on the item; and
a packaging station configured for packaging the item in a package including a window configured for exposing at least a portion of said content.

16. The system of claim 15, wherein said content includes order data related a purchase order of the item.

17. The system of claim 16, wherein said order data includes shipping data and/or a shipping label including postage for shipping the item and wherein said window is configured for exposing said shipping data and/or said shipping label.

18-29. (canceled)

30. A method for packaging an item in an automated process, the method comprising:
receiving the item and a packaging layer on a pallet of an automated packaging system for packaging the item in a package configured for shipping; and
folding the item and said packaging layer, wherein said folding forms said package with a window through which a selected portion of the item is visible therethrough, wherein said folding is performed by said automated packaging system in an automated process.

31. The method of claim 30, wherein folding the item is performed concurrently with forming said package in which the item is enclosed.

32. The method according to claim 30, wherein the folding includes rolling the item and said packaging layer to form said package.

33. The method according to claim 30, further comprising printing content on the item and/or said packaging layer, wherein said content is related to a purchase order of the item.

34. The method according to claim 30, comprising forming fold lines, micro-cuts and/or holes on said packaging layer.

35. The method according to claim 30, comprising cutting out a window in said packaging layer, wherein said window is configured to expose a portion of the item.

36. The method according to claim 30, further comprising:
printing shipping data on the item; and
aligning a window formed on said package to expose said shipping data through said window.

37. A method for packaging an item, the method comprising:
receiving the item on a pallet of an automated packaging system;
printing content on the item;
packaging the item in a package formed with a window; and
aligning said window with said content to expose at least a portion of said content.

38-48. (canceled)
